(19) United States
(12) Patent Application Publication
(10) Pub. No.: US 2010/0115730 A1
(43) Pub. Date: May 13, 2010

(54) Portable support for commuters

(76) Inventors: Rasheem Malik Holland, Brooklyn, NY (US); Lisa Therese Arnold, Brooklyn, NY (US)

Correspondence Address: Rasheem M. Holland / Lisa Arnold, Apt #1, 623 Emerald Street, Brooklyn, NY, 11208, US

(21) Appl. No.: 12/453,844

(22) Filed: May 22, 2009

Related U.S. Application Data
(60) Provisional application No. 61/071,906, filed on May 22, 2008.

(51) Int. Cl. B25G 1/10

(52) U.S. Cl. 16/422

(57) ABSTRACT

A portable support for standees of subways and buses assists in minimizing the spread of germs since a commuter needing or wanting to stand will only touch his or her personal Gripper devise versus touching the attached bar of a bus or subway that can be touched by multiple commuters. Pressing and removing a thumb from the release button of the device will allow the clamps to open and close, latching onto the bar of a subway or bus when a commuter needs to stand providing safety, support and sanitary conditions. The swinging motion allows for the standee to move forwards and backwards along with the movement of the bus or subway to a certain point, providing again necessary support and safety.

### CROSS-REFERENCE TO RELATED APPLICATIONS

This application claims the benefit of provisional patent application Ser. No. 61/071,906, filed May 22, 2008 by the present inventor.

### FEDERALLY SPONSORED RESEARCH

Not Applicable

### SEQUENCE LISTING OR PROGRAM

Not Applicable

### BACKGROUND OF THE INVENTION

1. Field of Invention

This invention generally related to subways or buses, specifically to commuters to hold onto.

2. Prior Art

Previously, subway car straps were bolted to the subway car. This made car straps unsanitary. Shortly after “9/11” tragedy, car straps were replaced with a single bar also bolted to the subway car. The single bar resolves the problem of safety and support for standees in subways however is not a solution for hygiene.

Accordingly, several objectives and advantages of my invention are that it is portable, thus hygienic, without sacrificing existing safety.

The following U.S. patents may be of interest for their disclosure of loose rings for books. U.S. Pat. No. 1,228,866.

The above-mentioned patent has a common characteristic. The patent device is two half rings joined together with a hinge to form a circle with an opening. The above-mentioned patent does not disclose a handle attachment device that is used by a commuter, such as a standing commuter in a mass transit vehicle to hold onto and attach the ring to a bar for support and resolves problems of sanitation.

Thus while the foregoing body of prior art indicates it to be well known to the use of ring for books and paper, the prior art described above does not teach or suggest a portable support device for a commuter with the following combination of desirable features: (1) permits a commuter to bring along one's own portable hold-on bar to provide oneself with stability (2) to permit a commuter to attach to the hold on bars in a mass transit vehicles.

Further objectives and advantages are novelty, comfort, reliability, durability and size, which allow persons of almost any age to carry and/or conceal the device without much effort.

### SUMMARY

My invention is a portable subway and bus support for commuters that provide safety, as well as promotes cleanliness by minimizing the spread of germs because a commuter needing or wanting to stand will only touch his or her personal Gripper device and not the attached bar that is held onto by multiple commuters.

### DRAWINGS—FIGURES

In the drawings closely related figures have the same number but different alphabetic suffixes.

FIG. 1 is a perspective view of my invention.

FIG. 2 is a bottom view of my invention

FIG. 3 is a top view of my invention.

FIG. 4a is a side closed clamp view of my invention.

FIG. 4b is a side open clamp view of my invention.

### DRAWINGS—REFERENCE NUMERALS

Handle 10a top portion of handle

Handle 10b front base of handle connecting to clamp

Handle 10c rear base portion of handle

Handle 10d inner portion of handle with finger grooves

Clamp 12b between front base of handle

Clamp 12a top part of handle

Clamp 12c bottom part of clamp

14 release button at front base of handle

Base 16d back bottom portion parallel to handle

Base 16c front bottom portion parallel to handle

18 sides of front base of handle

20 between rear handle and base

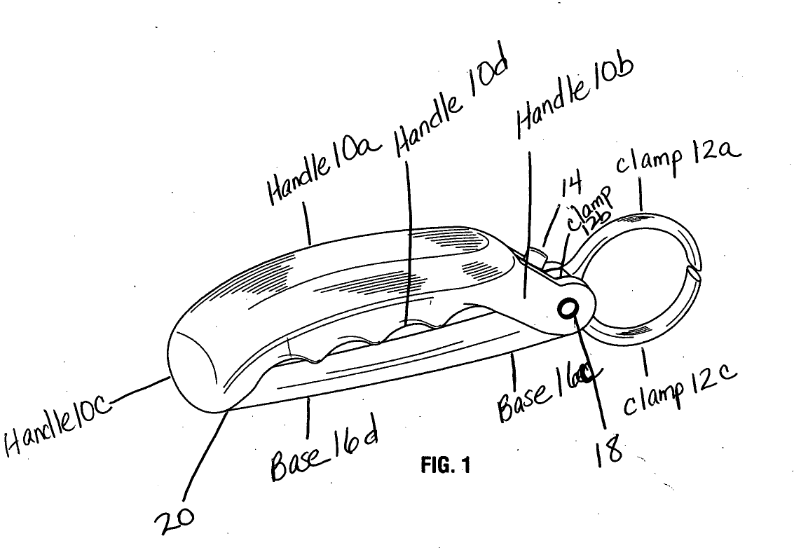

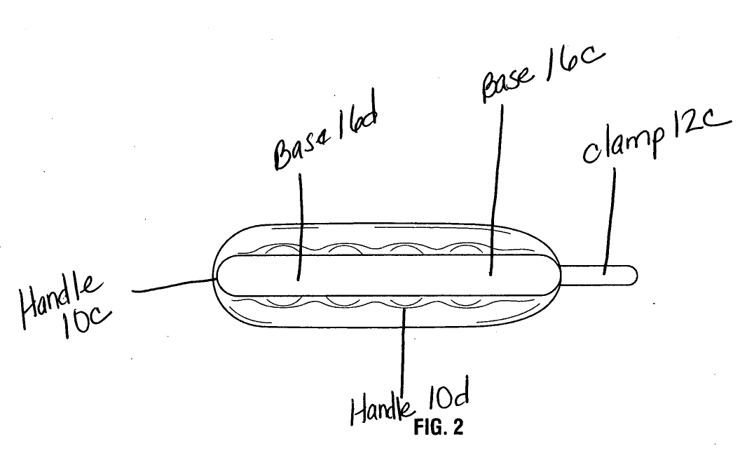

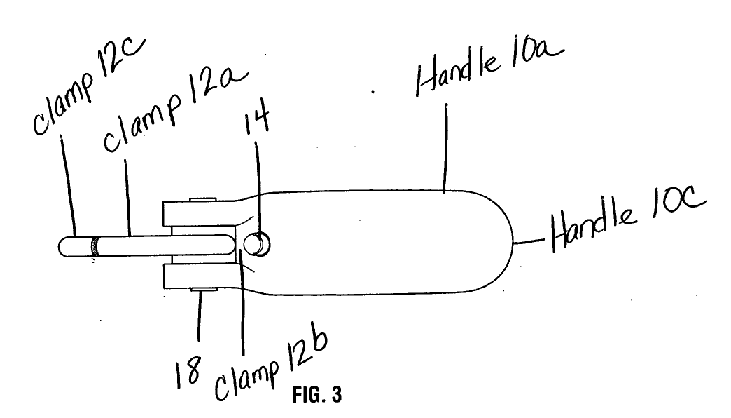

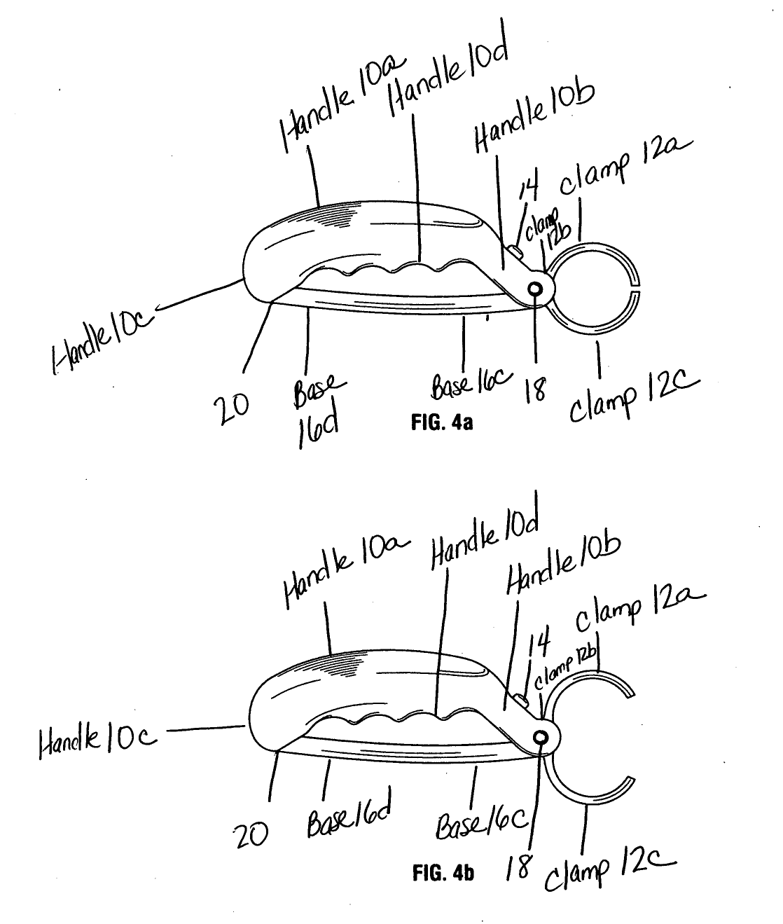

### DETAILED DESCRIPTION—FIGS. 1 AND 4a and 4b—PREFERRED EMBODIMENT

FIG. 1 shows a perspective view of a basic version of my apparatus. Handle 10a connects to base 16d with 20. Handle 10d is bottom side of handle 10a. Clamp 12a and clamp 12c connects handle 10b to base 16c with 18. 14 is between handle 10b.

In FIG. 1, handle 10a supports the palm of the palm of the hand. Handle 10d supports 4 fingers of a hand. 14 opens and closes clamp 12a and clamp 12c, as shown in FIGS. 4a and 4b. Being that clamp 12a and clamp 12 c opens and closes, it is portable and sanitary.

Thus, the reader will see that the Gripper device of my invention provides a highly sanitary, lightweight yet economical device that can be used by persons of almost any age.

Thus, while the present invention has been shown in the drawing and fully described above with particularity and detail in connection with what is presently deemed to be the most practical preferred embodiment(s) of the invention, it will be apparent to those of ordinary skill in the art that many modifications thereof may be made without departing from principles and concepts set forth herein, including but not limited to variation in size, material, shape, form, function and manner of operation, assembly and use. For example, as will occur to those of ordinary skill in the art, the device of the present invention may be used by a person of almost any age to attach to a public pull up bar to pull their weight of the ground.

Accordingly, the scope of the invention should be determined not by the embodiments illustrated but by appended claims and their legal equivalents.

I claim:

1. A method of gripping a handle comprising of:
gripping the handle with a left hand pressing a thumb of the left hand on a release button removing the thumb of said left hand off the release button and
hooking a clamp onto a bar

2. Said handle of claim 1 swings forward about 45 degrees and backwards to about a 180 degree alignment with the clamp, while supporting a person standing

3. Pressing the thumb and removing the thumb from the release button of claim 1 opens and closes said clamp around a bar to provide support for a person standing.

4. A method of gripping a handle comprising of:
gripping the handle with a left hand pressing a thumb of the left hand on a release button removing the thumb of said left hand off the release button and
hooking a clamp onto a bar

5. Said handle of claim 1 swings forward about 45 degrees and backwards to about a 180 degree alignment with the clamp, while supporting a person standing

6. Pressing the thumb and removing the thumb from the release button of claim 1 opens and closes said clamp around a bar to provide support for a person standing.

7. A method of gripping a handle comprising of:
gripping the handle with a left hand pressing a thumb of the left hand on a release button removing the thumb of said left hand off the release button and
hooking a clamp onto a bar

8. Said handle of claim 1 swings forward about 45 degrees and backwards to about a 180 degree alignment with the clamp, while supporting a person standing

9. Pressing the thumb and removing the thumb from the release button of claim 1 opens and closes said clamp around a bar to provide support for a person standing.
